(19) United States
(12) Patent Application Publication
(10) Pub. No.: US 2005/0048170 A1
(43) Pub. Date: Mar. 3, 2005

(54) Microwavable container for food products

(76) Inventor: Rick S. Huhn, Lauringburg, NC (US)

Correspondence Address: HOWREY SIMON ARNOLD & WHITE LLP, c/o IP DOCKETING DEPARTMENT, 2941 FAIRVIEW PARK DR, SUITE 200, FALLS CHURCH, VA, 22042-2924, US

(21) Appl. No.: 10/927,805

(22) Filed: Aug. 27, 2004

Related U.S. Application Data
(60) Provisional application No. 60/481,311, filed on Aug. 29, 2003.

(51) Int. Cl. C12C 1/027

(52) U.S. Cl. 426/106

(57) ABSTRACT

An expandable container for storing, transporting, and heating/cooking a microwavable food product, and method for forming the same is disclosed. The container expands into a substantially upright solid wall structure upon heating or opening by a user. The gradual expansion and/or extension of the container's wall panels to form substantially upright solid walls contains heat within the container to improve heating of the food product.

This application claims priority to U.S. Provisional Application No. 60/481,311, filed Aug. 29, 2003, which is hereby incorporated by reference.

### TECHNICAL FIELD

The present invention relates generally to microwavable containers for food products, and methods of fabrication thereof. The present invention relates more specifically to an expandable microwavable container for storing, shipping, heating and serving food products such as, but not limited to, popcorn, puffed cheese snacks and pork rinds.

### BACKGROUND

The increasing popularity of microwave cooking has lead to the development of several types of containers for microwave heating of food products. For example, a number of bag-type containers for microwave popping of popcorn are available. These containers are typically formed of paper or other flexible materials, and often include heating elements of microwave interactive susceptor material that absorb microwave energy to generate heat, which pops the popcorn. Various examples for forming a susceptor are disclosed in U.S. patent application Ser. No. 10/300,319, filed Nov. 20, 2002, having inventor Jeffrey T. Watkins, which is incorporated by reference herein. Such containers are typically shipped and stored in a folded configuration and, upon heating and popping of the corn, unfold into an expanded configuration.

Rigid containers have also been developed, such as tub-shaped containers for microwave heating of popcorn. These containers typically are in the form of generally frustoconical paperboard tubs having open tops. Examples of open tub designs are illustrated in U.S. Pat. No. 6,320,172 and U.S. patent Publication No. 20030080121, both are incorporated by reference in their entirety. A microwave susceptor is installed on or around the floor of the tub, and a quantity of unpopped corn and cooking oil or shortening is placed on the floor in the tub's interior. A plastic film or other barrier material is applied over the food stuff to seal out external contaminants, seal in moisture, and preserve freshness.

With the increased buying and renting of movies by consumers to watch and enjoy in their homes, the appeal for popcorn in tub type containers similar to that sold in movie theaters has increased. In addition, tub containers are typically more sturdy and easier to handle than microwave popcorn bags. Heretofore, tub-type containers for microwave popcorn were stored, shipped, and heated as open-mouth containers. Although this style container often allows nesting of multiple containers, the open-mouth design makes the food product more susceptible to damage and contamination.

Moreover, the open-mouth design also increases the likelihood of damage to the barrier material that lines the tub and covers the food product. For example, nesting the containers can cause damage to the barrier material. This damage can include puncturing the barrier material causing air to enter the space between the barrier material and the tub's interior, resulting in food product moisture loss. Moisture loss from popcorn inhibits popping and reduces popped volume. Other damage can include the barrier material becoming detached from the tub interior or any applicable barrier seals. Moreover, puncture or premature detachment of the barrier material results in uneven cooking and heat loss during cooking of the food product.

Another drawback to microwave cooking in open-mouth tubs is the increased heat loss due to the open volume,:which can result in slower food product heating. In addition, the tub's configuration makes it susceptible to damage from external forces being applied to the tub's exterior surface. For example, because the food product is typically stored on the tub's bottom surface, the majority of the tubs volume is empty. Because the tub is typically made of a type of paper material, the tub's upper portion is susceptible to damage from external forces, such as the tub falling from a shelf or being crushed during shipping.

Thus, there is a need for a container for microwave cooking of food products that overcomes disadvantages of previously known containers. A need further exists for an economical and efficient method of fabricating such a microwavable food container.

### SUMMARY

In accordance with one aspect of the invention, there is provided an expandable microwave food container that expands into a substantially upright solid wall structure upon heating or upon opening by a user. The container protects both the food products and any potential barrier material within the container from damage and/or contamination. The container is also useful for both sealing in and/or keeping out moisture from the food product. In addition, the gradual expansion and/or extension of the container's wall panels to form substantially upright solid walls contains heat within the container to improve heating of the food product.

Other aspects, features, embodiments and advantages of the invention will be or will become apparent to one with skill in the art upon examination of the following figures and detailed description. It is intended that all such additional aspects, features, embodiments and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 shows a perspective view of an expandable container in an open position according to an embodiment of the present invention.

FIG. 2 shows a cross-sectional elevation of a the container illustrated in FIG. 1.

FIG. 3 shows a perspective view of a container according to another embodiment of the present invention.

FIG. 4 shows a perspective view of the container illustrated in FIG. 3 with the container in the closed position.

FIG. 5 shows a perspective view of an alternative embodiment of that depicted in FIG. 4.

### DETAILED DESCRIPTION

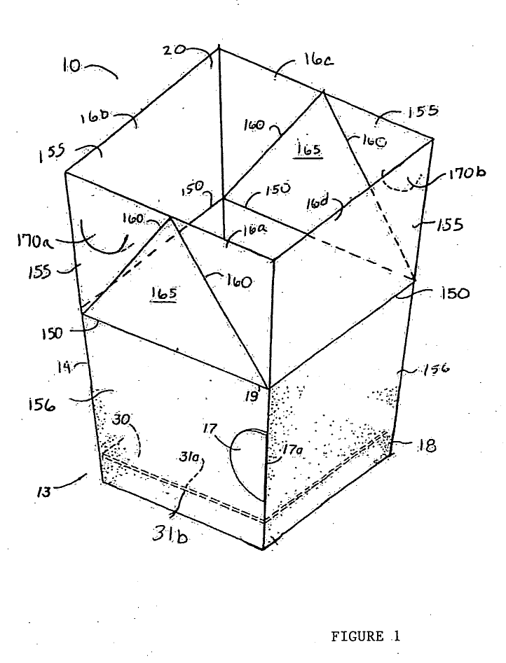

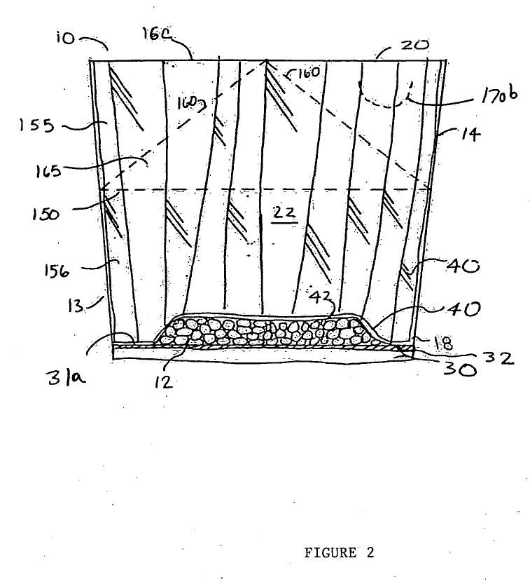

Referring now to the drawing figures, wherein like reference numerals represent like parts throughout unless specifically indicated otherwise, various embodiments of the present invention will now be described. With reference to FIG. 1, one embodiment of the present invention is shown. As illustrated in FIGS. 1 and 2, a container 10 for microwave heating, as with a standard microwave oven, of a food product 12 is shown. The food product 12 may be, for example, popcorn, pork rinds, puffed cheese snacks, or other food product. The container 10 is particularly well-suited for, but is not limited to, the heating of food products 12 that expand or puff when cooked. The container can also be used to heat beverages, such as coffee or tea. Cooking oil, shortening, spices, preservatives, flavorings, stabilizers, colorants, or other substances may be included with the food product 12. Moreover, one or more surfaces of the container 10 can be printed, labeled or otherwise provided with text, graphics or other features for marketing, informational or source indicating purposes.

The container 10 preferably includes a tub assembly 13 having a substantially upright sidewall assembly 14, formed of paperboard, paper, cardboard, plastic, or other foldable, moldable or deformable material. Acceptable results may be obtained, for example, using 15, 18 or 24 point SBS (solid bleached sulfate) paperboard. The material(s) of construction used to form the sidewall assembly 14 are selected to result in a container 10 that is substantially rigid (i.e., capable of supporting the weight of the container 10 and its contents in normal use by a consumer without unintended deflection), and to provide economy and ease of fabrication. One or both of the interior and exterior faces of the sidewall assembly 14 can comprise a coating, laminate, coextrusion or other treatment, such as for example polyethylene or other polymer(s), flourocarbon treatment or wax, to provide a barrier against staining or absorption of oils, water or other liquids from the food product 12. As a representative example, a flourocarbon treatment sold under the tradename FC807 by the 3M Company can be applied to the sidewall assembly 14.

The sidewall assembly 14 includes at least one wall panel 16a-d. As illustrated in FIG. 1, multiple substantially flat wall panels 16a-d form a multi-walled, polygonal container 10. Although the tub is shown having a substantially rectangular shape, any suitable shape is considered within the scope of the present invention, such as, but not limited to a generally cylindrical or frustoconical container 10. The sidewall assembly 14 preferably further includes a base portion 18 at the lower edge of the wall panels 16a-d, which is adapted to rest on a support surface such as the floor of a microwave oven (not shown), and maintain the container 10 in a stable, upright position. The upper extent of the sidewall assembly 14 preferably comprises an open mouth 20 providing access to the interior volume 22 bounded by the sidewall assembly 14.

Referring to FIGS. 1 and 2, the tub assembly 13 can also include a floor portion 30 extending generally horizontally from the wall panels 16a-d. The floor portion 30 has an interior face 31a defining the lower boundary of the interior volume 22 of the container 10, and an exterior face 31b opposite the interior face 31a. The floor 30 comprises a moisture-impervious material to prevent moisture loss from food product 12 encapsulated thereby, as will be described below. The floor 30 is preferably formed from a moisture barrier material or is provided with a moisture barrier coating or layer along substantially its entire interior face. Acceptable results have been obtained, for example, using 20 or 24 point SBS paperboard with a 2 mil polyester laminated on its interior face. Alternatively, acceptable results can be obtained by using 12.5-13 point SBS paperboard laminated on its interior face with 8 lb./ream nylon. Other polymer coatings, laminates, coextrusions or layerings, such as for example: polypropylene; polyvinyl dichloride (PVDC)-coated nylon; PVDC-coated polyester; and/or polyester and polypropylene composites, may be used to provide substrate materials such as paperboard, cardboard, paper or plastics with acceptable barrier properties.

The floor 30 can be integrally formed with the wall panels 16a-d, or can be a separate component attached to the wall panels by adhesive, folding, crimping, or other conventional attachment means. A microwave susceptor 32, such as a 48-gauge or 2 mil metallized polyester film, vacuum deposited metal, carbon or metallic based coatings, laminates, inks or print, other microwave interactive material(s), or any combination of them, is preferably disposed on the floor 30. The susceptor 32 is preferably laminated or otherwise affixed to the interior face 31a of the floor 30. Alternatively, the susceptor 32 can be laminated or otherwise affixed to the exterior face 31b or be integral with the floor 30. The susceptor 32 is preferably sized and placed to be underlying at least the portion of the floor 30 upon which food product 12 is initially placed.

Referring to FIG. 2, the container 10 further comprises a sheet of barrier material 40 forming a pocket 42 for containing a quantity of the food product 12. The sheet of barrier material 40 can go up along the walls 16a-d anywhere between the bottom of the walls 16a-d and the top of the walls 16a-d. Indeed, as shown in FIG. 2, the sheet of barrier material 40 goes up to near the top of the walls 16a-d. In another embodiment (not shown), the sheet of barrier material 40 just covers the floor 30 and does not go up the walls 16a-d at all. The pocket 42 is preferably generally centered on the floor 30, and does not normally extend to the exterior edges of the floor 30 where it joins with the bottom of wall panel 16.

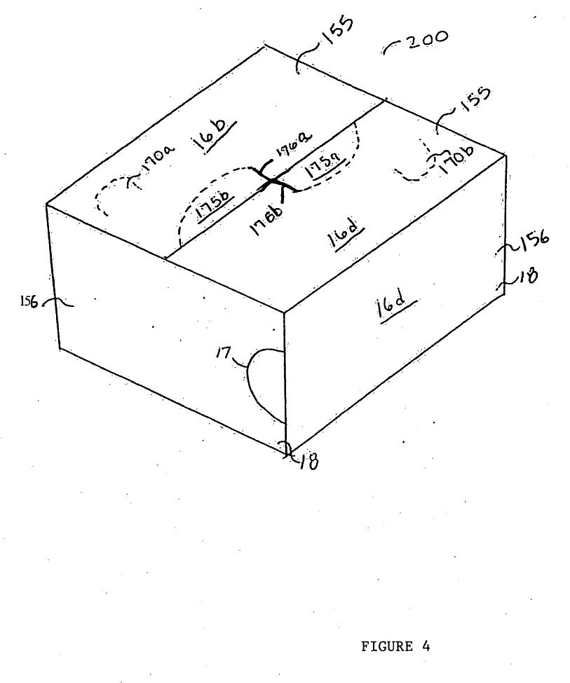

Referring back to FIG. 1, as shown, wall panels 16a-d have horizontal creases 150 located at approximately a ⅔ distance above the base portion 18. The horizontal creases 150 can be at any suitable location. For example, rather than being ⅔ distance from the base 18, the horizontal creases 150 can be located substantially near the base 18 so that, as described in more detail below, the diagonal folds 160 extend at a substantially diagonal length of wall panels 16a-d. With this feature, the closed position of the container 10 as generally illustrated in FIG. 4 results in a substantially flat package, which expands into an upright tub assembly.

Referring back to FIG. 1, horizontal creases 150 divide wall panels 16a-d into an upper section 155 and a lower section 156. The upper section 155 of wall panels 16a and 16c include substantially diagonal folds 160, which form triangular sections 165. In order to close the container 10, triangular sections 165 are pushed inward, which cause the upper sections 155 of wall panels 16a and 16c to inwardly fold down and towards each other in order to become substantially parallel with the container floor 30. As the upper sections 155 of wall panels 16a and 16c are inwardly folded, the upper sections 155 of wall panels 16b and 16d are forced to inwardly fold, which results in upper sections 155 of wall panels 16b and 16d overlapping upper sections 155 of wall panels 16a and 16c, thereby creating a top cover for the container 10. An example of an alternative embodiment showing the container in the closed position is illustrated in FIG. 4. Details of FIG. 4 will be discussed below.

As shown in FIG. 1, one or more handles, projections or other surface features may be provided to assist in handling the container 10. For example, at least one optional handle 17, as shown in FIG. 1, is especially helpful after the heating of food products and the container 10 may be hot. Optional handle 17 is a flap extending away from the wall panel 16d and can be folded along an upwardly extending axis that is substantially non-horizontal, such as edge 17a, so as to position the handle 17 against an adjacent wall panel, 16a as shown in FIG. 1. This foldable characteristic of handle 17 allows handle 17 to move between an inoperative position where handle 17 is co-planar with the wall panel 16a and an operative position where handle 17 extends away from the wall panel 16a. The handle 17 is preferably an integral part of wall panel 16d. Alternatively, handle 17 can be a separate element that is attached or fixed to the wall panel 16d. For instance, handle 17 can be a separate piece of paperboard, paper, cardboard, plastic, or other foldable, moldable or deformable material having a sticky end that can be stuck to the wall panel 16 prior to use by the consumer. In another circumstance, the handle 17 can be separately included with the container and attached by the consumer at a location of his/her choice. Although the handle 17 is associated with the wall panel 16d in the embodiment shown in FIG. 1, handle 17 can be associated with any of the wall panels 16a-16d. Additionally, the substantially upright or vertical axis about which handle 17 pivots can be located on any of the wall panels 16a-16d at any desired location thereon. Also, more than one handle can be utilized to further facilitate handling of the container 10.

An additional handle (not shown) similar to that of handle 17 can extend away from the wall panel 16b and can be folded along an upwardly extending axis that is substantially non-horizontal, such as the edge created by the intersection of wall panels 16b and 16c, so as to position the handle against an adjacent wall panel, such as wall panel 16c. In this arrangement, the handles are approximately diagonally opposite, so as to assist in the handling of the container 10.

Also illustrated in FIG. 1 are secondary handles 170a and 170b located on and/or within wall panels 16a, and 16c, respectively. Similar to handle 17, secondary handles 170a and 170b assist a user in handling the container 10, particularly after the food product has been heated or cooked within the container 10. Optional handles 170a and 170b are flaps that fold upward and extend away from the interior of the container 10. This foldable characteristic of handle 170a and 170b allows the handles to move between an inoperative position where handle 170a is co-planar with the wall panel 16a and an operative position where handle 170a extends away from the exterior surface of the wall panel 16a, capable of being substantially perpendicular to wall panel 16a. Similarly, in an inoperative position handle 170b is co-planar with wall panel 16c and an operative position handle 170b extends away from wall panel 16c, where secondary handle 17b is capable of being substantially perpendicular to wall panel 16c. The handles 170a and 170b are preferably integral parts of wall panels 16a and 16c, respectively. Alternatively, handles 170a and 170b can be separate elements and attached or fixed to the wall panels at a location of the user's choice. For instance, handles 170a and 170b can be a separate pieces of paperboard, paper, cardboard, plastic, or other foldable, moldable or deformable material having a sticky end that can be adhered to the wall panels 16a-16d using glue or another adhesive prior to use by the consumer. Note that although the handles 170a and 170b are associated with the wall panel 16a and 16c, as shown in FIG. 1, handles 170a and 170b can be associated with any of wall panels 16a-16d. For example, handles 170a and 170b can be on the same panel, adjacent panels, or opposite panels.

Additionally, as illustrated in FIG. 1, the handles 170a and 170b are located at a diagonally opposite distance. In this aspect, it allows for a user to better handle the container 10. Also, although handles 170a and 170b are located on the upper sections 155 of wall panels 16a and 16c, the handles could be located in any suitable location. For example, handles 170a and 170b could be located on the lower sections 156 of wall panels 16a and 16c. Alternatively, handle 170a could be located on the left of lower section 156 of wall panel 16a, while handle 170b could be on the right of upper section 155. In this configuration, the location of the handles 170a and 170b, allows a user to grasp both the lower section 156 of container 10 as well as the container's upper section 155, which can result in a user having and maintaining better control of the container 10. In addition, although secondary handles 170a and 170b are shown as lifting upward, the handles 170a and 170b can also be configured so that they have a downward pull instead.

Once the food product 12 starts to cook and expand within the container 10, the expansion of the food product 12 results in the expansion of the upper sections 155, expanding outward to open the container 12. In this respect, air pockets and/or other expandable material, such as the barrier material 40, can be configured to cause handles 170a-b to pop up, i.e., go from their inoperative, co-planar positions with their respective wall panel, to their operative, extended positions at least partially. In this aspect, the user does not have to attempt to force by pulling or pushing the secondary handles to their operable positions, thereby reducing damage to the barrier material 40 caused by the user attempting to push and/or pull the tabs 170a-b in an outward direction.

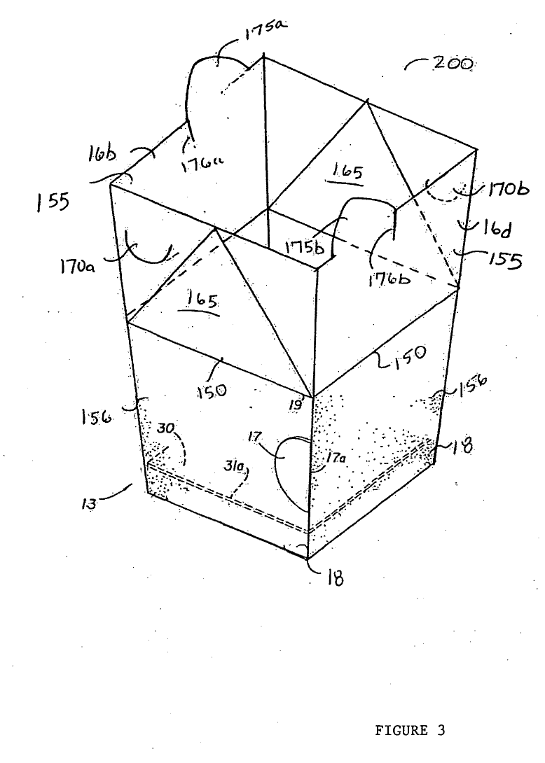

Referring to FIG. 3, a container 20 in accordance with alternative embodiment of the present invention is shown. In this embodiment, atop wall panel's 16b upper section 155 is tab 175a. In addition, a slit 176a is located adjacent a bottom portion of tab 175a. Similarly atop wall panel's 16d upper section 155 is tab 175b and slit 176b is located adjacent a bottom portion of tab 175b. In this embodiment, tabs 175a and 175b and slits 176a and 176b form a locking mechanism for the container 200 when it is in the closed position.

When the container 200 is in its closed position (i.e. triangular sections 165 are pushed inward to form a cover for the container 200) as illustrated in FIG. 4 by the hidden lines, tab 175b via slit 176a is interlocked with a portion of the upper section 155 of wall panel 16b, resulting in tab 175a being substantially hidden under the upper section 155 of wall panel 16b. Similarly, tab 175a via slit 176b is interlocked with a portion of the upper section 155 of wall panel 16d, resulting in tab 175b being substantially hidden under the upper section 155 of wall panel 16d. Although FIG. 4 shows the container 200 using tabs 175a and 175b and slits 176a and 176b forming a locking mechanism for the container 200. In another aspect of this embodiment, the locking mechanism can consist of a partially perforated pull strip and tab interface such as that used atop cereal boxes.

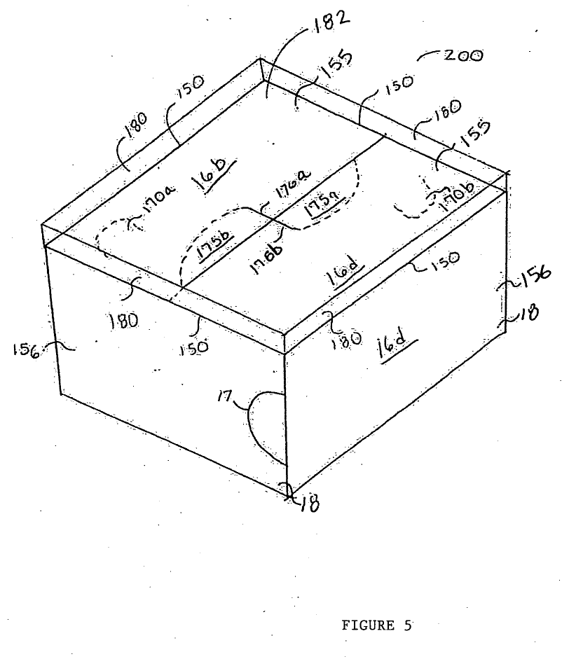

Referring to FIG. 5, another embodiment of the present invention is shown. In this embodiment, an upper ridge portion 180 is shown that is defined by the perimeter of the closed container 200 along creases 150. As shown, when container 200 is closed, upper ridge portion 180 forms a secondary open-top container 182 having as its base the upper sections 155 of wall panels 16b and 16d. The upper ridge portion 180 can be integral to the wall panels or it can be a separate piece or pieces that are attached in some manner, such as with an adhesive to the exterior surface of the wall panels 16a-d. As previously illustrated in FIGS. 1-4, the base portion 18 of containers 10 and 200 is tapered so that the perimeter of the containers 10 and 200 increases as you move up along the exterior portion of the containers 10 and 200. Thus, the secondary container 182 illustrated in FIG. 5 has a larger area than that of the base portion 18. This allows the secondary container 182 to receive the base portion 18 of containers 10 and 200, thereby providing for the convenient and secure stacking of the containers 10 and 200. This is particularly useful for shipping, storing, and displaying the containers 10 and 200.

Although the foregoing exemplary embodiments illustrate the containers 10 and 200 as being substantially rectangular, it can be appreciated that in other aspects of the present invention, the container may have a cylindrical shape, or be made of a container having N wall panels, wherein N is an integer with a value of at least three. For example, the containers 10 and 200 can be square, triangular, pentagonal, or hexagonal in shape. In addition, the wall panels can be the same or different lengths. Moreover, the container can be made of either a single piece of material, such as a unitary paperboard sidewall blank, such as that described in U.S. Pat. No. 6,320,172, or it can comprise a plurality of sections, such as those also described in U.S. Pat. No. 6,320,172, both of which are incorporated by reference herein. In addition, although the Figures illustrate the base portion 18 of containers 10 and 200 as being substantially flat, the base portion can be raised, such as that depicted in U.S. Pat. No. 6,320,172.

Moreover, although the Figures herein illustrate the inwardly folding sections as having a triangular shape, the inwardly folding sections can any suitable shape. For example, alternate folds can include but are not limited to the triangular sections being located at the corners of the wall panels, where the wall panels intersect with the adjacent wall panels. In addition, rather than having triangular sections, pleats could be used. Further, although the Figures illustrate the triangular sections as being on only two opposing panels, the triangular section could be located on all or fewer that all of the panels. In addition, the lower section 156 of containers 10 and 200 can be made of different material or have a different thickness than that of the upper section 155.

In use, a consumer can cook or heat the food product 12 with the container 10, 200 being closed as illustrated in FIG. 4. Once the food product 12 is heated, it starts to expand within the container 10, 200, as the food product expands the upper sections 155 wall panels 16a-d gradually extend outwards forming substantially upright wall panels 16a-d. The gradual extension and resultant wall formation helps to contain heat within the container 10, 200 to heating of the food product 12. Moreover, using the covered container can speed the cooking time of the food product, because of its ability to retain heat within the container 10, 200 during the gradual extension of the wall panels 16a-d. It is preferable to heat the food product 12 with the container 10, 200 starting in the closed position. However, the food product can also be heated with the container 10, 200 being open.

The particular embodiments disclosed above are illustrative only, as the invention may be modified and practiced in different but equivalent manners apparent to those skilled in the art having the benefit of the teachings herein. Furthermore, no limitations are intended to the details of constructions or designs herein shown, other than as described in the claims below. It is therefore evident that the particular embodiments disclosed above may be altered or modified and all such variations are considered within the scope of the invention. Accordingly, the protection sought herein is as set forth in the claim below.

1. A microwavable food container, comprising:
a floor; and
a plurality of sidewalls extending from the floor to form an interior volume of the container, each of the sidewalls having a lower section attached to the floor and an upper section foldably attached to the lower section;
wherein the upper sections of the sidewalls are movable between a closed position and an open position;
wherein in the closed position, the upper sections are folded over to form a top of the container and to define a reduced interior volume of the container;
wherein in the open position, the upper sections are extended into substantially upright positions that are substantially coplanar with their respective lower sections to define an open top of the container and to define an expanded interior volume of the container.

2. The container of claim 1, wherein the upper sections move toward the open position upon heating a food product stored in the container.

3. The container of claim 1, further comprising a food product placed in the interior volume of the container.

4. The container of claim 1, further comprising a barrier material, located in the interior volume of the container for protecting a food product.

5. The container of claim 1, further comprising plural handle flaps located on the exterior of the container.

6. The container of claim 1, wherein the handle flaps are located at junctions between the lower sections.

7. The container of claim 5, wherein the handle flaps are integrally formed on two or more of the upper sections.

8. The container of claim 7, wherein the handle flaps are in an inoperative position when the upper sections are in the closed position and the handle flaps assume an operative position when the upper sections are in the open position.

9. The container of claim 1, wherein at least two of the upper sections include a locking mechanism for securing the upper sections in the closed position.

10. The container of claim 9, wherein the locking mechanism includes opposing tabs extending from opposing upper sections; and slits formed in each of opposing upper sections for receiving at least a portion of the opposing tabs.

11. The container of claim 1, wherein the container includes four sidewalls for forming a substantially rectangular-shaped container.

12. The container of claim 1, wherein the sidewalls taper in near the floor so that the container is narrower at its bottom than at its top.

13. The container of claim 1, further comprising a microwave susceptor located at the floor of the container.

14. The container of claim 1, further comprising an upper ridge position defined by the perimeter of the top of the container in the closed position.
